(19) United States
(12) Patent Application Publication
(10) Pub. No.: US 2023/0102479 A1
(43) Pub. Date: Mar. 30, 2023

(54) ANONYMIZATION DEVICE, MONITORING APPARATUS, METHOD, COMPUTER PROGRAM, AND STORAGE MEDIUM

(71) Applicant: Robert Bosch GmbH, Stuttgart (DE)

(72) Inventor: Dieter Joecker, Burgthann (DE)

(21) Appl. No.: 17/911,488

(22) PCT Filed: Jan. 29, 2021
(86) PCT No.: PCT/EP2021/052116

§ 371 Date: Sep. 14, 2022

(30) Foreign Application Priority Data
Mar. 18, 2020 (DE) 10 2020 203 475.3

(51) Int. Cl. G06V 40/16; G06V 20/52; G06V 20/40; G06V 10/82

(52) U.S. Cl. CPC G06V 40/168; G06V 20/52; G06V 20/40; G06V 10/82

(57) ABSTRACT

The invention relates to an anonymisation device (6) for generating anonymised images (9), wherein video monitoring of a surveillance area (3) by means of at least one camera (2) provides surveillance images (5), said device comprising: an identification module (11), the surveillance images (5) being provided to the identification module (11), and the identification module (11) being designed to identify persons (4) included in the surveillance images (5); and a processing module (13), the processing module (13) being designed to process the surveillance images (5) to produce the anonymised images (9), and at least one person (4) or person section (4a, b) included in the surveillance images (5) being anonymised in the anonymised images (9). The identification module (11) is designed to record personal information of the identified person (4), and the processing module (13) is designed to produce, on the basis of the personal information, an artificial person model (14) in order to anonymise the person (4).

### BACKGROUND OF THE INVENTION

The invention relates to an anonymization device for the generation of anonymized images. The invention furthermore relates to a surveillance apparatus, a method, a computer program and a storage medium.

Very large quantities of data are required in order to train neural networks, artificial intelligences and algorithms for automated data processing in order to be able, for example, to train person detection systems with an adequately good performance. For this purpose, image and/or video recordings from public spaces are often used, for example in the field of security technology, but often comprise personal information, for example the image of the person in a video recording. Legal regulations for protecting personal data impose tight limits on the use of such recordings. In order to make persons in image data unrecognizable, the corresponding regions of the persons have until now been pixelated and/or made unrecognizable through black boxes. However, if such a person is made unrecognizable in this way, the data cannot be used to be able to carry out developments, tests and/or training of image processing systems.

The document DE 10 2016 223 859 A1, which does indeed represent the closest prior art, describes a camera for monitoring a surveillance region in which an unmasked surveillance image is recorded by means of a camera sensor and the unmasked surveillance image is processed by means of an integrated evaluation unit into a masked output image, wherein the personally specific region has here been made unrecognizable.

### SUMMARY OF THE INVENTION

An anonymization device for the generation of anonymized images according to the invention is proposed. A surveillance apparatus, a method, a computer program and a storage medium according to the invention are furthermore proposed. Preferred and/or advantageous embodiments of the invention emerge from the dependent claims, the description and the appended figures.

The invention relates to an anonymization device that is designed and/or suitable for the generation of anonymized images. The anonymization device serves in particular to provide anonymized images that are preferably based on non-anonymized images. The term “anonymized images” refers in particular to images that conform to the European General Data Protection Regulation. Anonymized images are furthermore preferably images in which a person has been anonymized, changed and/or made unidentifiable. In particular, anonymized images are images in which a person represented in the anonymized images cannot be traced back and/or restored to the original, real person. The anonymization device can be designed as a software module or as a hardware module, for example as a computer chip or a computing unit.

A surveillance region can be monitored and/or is monitored by means of a camera. The surveillance region is, for example, an interior region or an exterior region. The surveillance region is preferably a public region, for example a public authority, an airport or a railway station. The surveillance region can, in particular, be a region of a vehicle, monitored, for example, for autonomous driving. The camera is preferably arranged and/or can be arranged in the surveillance region. The monitoring takes place in particular using a video camera, for example a color, monochrome, 3D or infrared camera. The monitoring of the surveillance region with the camera is performed for the provision of surveillance images. The surveillance images show the monitored surveillance region and, in particular, persons who are located in the surveillance region. The surveillance images correspond in particular to a real and/or non-anonymized image of the surveillance region. The camera is in particular designed to generate an individual image, a number of images and/or a data stream of images, in particular a video sequence, as a surveillance image.

The anonymization device comprises a recognition module. The recognition module is preferably designed as a hardware component and/or a software component in the anonymization device. The surveillance images are provided through data technology, for example by means of a wireless or wired connection, to the recognition module. The recognition module in particular is designed to analyze and/or to process the surveillance images. At least one person, or precisely one person, can be located or remain in the surveillance image, in particular temporarily or permanently. The recognition module is designed to detect one person, some persons and/or all persons in the surveillance image on the basis of the surveillance images. The recognition module is in particular designed to examine the surveillance images on the basis of rules, for example predefined parameters and/or characteristics, wherein the parameters are designed for finding persons and/or for distinguishing between persons and background. The recognition module is in particular designed to detect the persons by means of a model-based method.

The anonymization device comprises a processing module. The processing module is preferably designed as a hardware component and/or a software component in the anonymization device. The processing module is designed to process the surveillance images into the anonymized images, wherein for this purpose at least one of the recognized persons or person segments is anonymized in the anonymized images. The processing module is in particular designed to anonymize one, some or all of the persons and/or person segments of the persons. In particular, a person segment refers one or a plurality of bodily parts and/or bodily regions such as, for example, the lower body, upper body, head, face and so forth of the person. The person and/or person segment that was recognizable in the surveillance images is shown in the anonymized images in an anonymized form. Anonymized means in particular that the person or the person segment cannot be recognized and/or identified by a non-expert and/or third party. The recognition module is, for example, designed to detect persons in the surveillance images and/or to determine regions in which the persons are represented, wherein the detected persons and/or person segments are then anonymized by the processing module. It can, in principle, be provided that the entire person is anonymized. Alternatively, it is provided that only specified person segments are anonymized, wherein other person segments remain real and/or unprocessed.

It is proposed in the context of the invention that the recognition module is designed to capture personal information relating to the person. In particular, the personal information comprises a personal feature or a feature associated with the person, in particular at least or precisely one abstract personal feature of the recognized person. The processing module is preferably designed to extract the personal information relating to the recognized person from the surveillance images. The personal information is preferably made available to the processing module. In order to anonymize the person or the person segment, the processing module is designed to create a synthetic person model on the basis of the personal information. In particular, the processing module is used to anonymize the person or the person segment in the surveillance images by replacing or overlaying said person with the person model. The synthetic person model is preferably an artificially generated model of the recognized person or person segment that has a realistic appearance, wherein personal data and/or data relevant to data protection law are eliminated, in particular. Particularly preferably, the synthetic person model comprises one, some or all abstract personal features of the recognized person. Anonymized images that are prepared by the processing module are in particular further useful as a training dataset and/or in image processing, so that such apparatuses can draw relevant data from these images.

The advantage of the invention is, in particular, that the processing module proposes an anonymization device that permits an anonymization of persons in the surveillance images, wherein important visible features of the persons are retained at the same time. The anonymized images can thus, for example, be used for training or testing algorithms without providing personal data. In particular, the anonymization device is designed to generate the anonymized images in situ, for example in the surveillance region or the camera, with the result that images that are relevant to data protection law do not need to be transmitted and/or further data protection security precautions need to be taken.

In one specific configuration, it is provided that the processing module comprises a generative generic network for generating the synthetic person model. Generative generic networks are also known as generative adversarial networks (GAN), in particular. Generative generic networks comprise, in particular, a generator and a discriminator, which can be understood as a player and an opponent, wherein the generator attempts to generate synthetic person models and the discriminator attempts to identify synthetic person models as such. For example, the generative generic network is designed on the basis of a “Style-Based Generator Architecture”, as described in “A Style-Based Generator Architecture for Generative Adversarial Networks” Tero Karras et al., NVIDIA, (arXiv:1812.04948v3), the content of which is hereby incorporated in this application. The aim of the processing module and/or of the generative generic network is, in particular, to generate person models which are anonymized as far as possible and can be used and/or used further in the anonymized images, in particular as training data.

In a further concretization, it is provided that the personal information comprises at least or precisely one movement feature of the recognized person. In particular, the at least one movement feature describes a movement and/or a behavior of the person in the surveillance image. The at least one movement feature preferably describes a movement behavior and/or a movement pattern and/or a direction of movement and/or a movement speed of the recognized person. Alternatively, the movement feature or optionally additionally a further movement feature describes a facial expression and/or gestures of the recognized person. Alternatively or optionally additionally, it is provided that the personal information comprises at least or precisely one appearance feature of the recognized person. In particular, the at least one appearance feature describes a stature, preferably a body size and/or a body stature and/or bodily posture, of the person in the surveillance image. Alternatively or optionally, the appearance feature or a further appearance feature describes an appearance, preferably a gender and/or hair color and/or skin color and/or clothing, of the person.

In a further embodiment, it is provided that the processing module is designed to animate the person model on the basis of the personal information in order to generate an animated synthetic person model. In particular, the processing module is designed to visualize or represent at least one movement feature, in particular a movement, of the person in the person model in order to animate the synthetic person model. The processing module is preferably designed to transfer at least one movement feature of the recognized person to the synthetic person model, with the result that the animated person model has the same movement features as the real person in the surveillance images. The invention therefore considers proposing an anonymization device which is distinguished by transferring the movement from the real person to the animated person model. It is therefore possible to generate anonymized images which can be analyzed and, at the same time, conform with data protection.

In a further configuration of the invention, it is provided that the personal information comprises at least or precisely one facial feature of a face of the recognized person. In particular, the recognition module is designed to analyze the face of the person and to extract the at least one facial feature. The processing module is designed to form a synthetic face model as the synthetic person model or as part of the synthetic person model on the basis of the at least one facial feature of the recognized person. The processing module is preferably designed to transfer at least one facial feature to the synthetic face model, with the result that the synthetic face model comprises the same facial features as the real face of the recognized person. In this case, the facial feature may be a movement feature, for example a facial expression, a direction of view or the like. The processing module is preferably designed to animate the synthetic face model on the basis of the movement feature. Alternatively, the at least one facial feature or optionally additionally at least one further facial feature may be an appearance feature, for example skin color, gender, age, hairstyle or the like. The processing module is preferably designed to model the synthetic face model on the basis of the appearance feature.

In one optional configuration, it is provided that the personal information comprises at least or precisely one body feature of a body or of at least one bodily part of the recognized person. In particular, a body refers to the entire body or the entire visible part of the body of the recognized person. In particular, a bodily part refers to one or more bodily segments, for example upper body, lower body, and/or one or more extremities of the body. In particular, the recognition module is designed to analyze the body or the at least one bodily part of the person and to extract the at least one body feature. The processing module is designed to form a synthetic body model as the synthetic person model or as part of the synthetic person model on the basis of the at least one body feature of the recognized person. In particular, the synthetic person model may be composed of the synthetic face model and the synthetic body model. The processing module is preferably designed to transfer at least one body feature to the synthetic body model, with the result that the synthetic body model has the same body features as the real body of the recognized person. In this case, the body feature may be a movement feature, for example a facial expression, a direction of movement or the like. The processing module is preferably designed to animate the synthetic body model on the basis of the movement feature. Alternatively, the at least one body feature or optionally additionally at least one further body feature may be an appearance feature, for example body stature, body size, clothing or the like. The processing module is preferably designed to model the synthetic body model on the basis of the appearance feature.

In a further implementation, it is provided that the processing module is designed to insert the synthetic person model instead of the person or the person segment into the anonymized image. In particular, the processing module is designed to replace at least the face of the real person with the synthetic face model. Optionally, the body or at least one bodily part of the recognized person may be replaced with the synthetic body model. The processing module is preferably designed to completely replace the recognized person with the synthetic person model, with the result that the person is completely anonymized. In particular, the anonymization is carried out by means of the processing module during ongoing operation and/or instantaneously. An anonymization device is therefore proposed, the anonymized images provided by which device are anonymized to the extent that a third party cannot infer the person in the surveillance images from the anonymized images.

In one development, it is provided that the anonymization device has a segmentation module which is designed and/or suitable for segmenting the surveillance image into a person region and a background region. In particular, the segmentation module is designed to segment the surveillance image into a plurality of person regions and/or background regions. For this purpose, the segmentation module may determine a plurality of person regions for a plurality of persons in a surveillance image, for example. The plurality of person regions and/or background regions may be contiguous and/or fragmented. The person region is, in particular, that region which is occupied by the person in the surveillance image and/or by the synthetic person model in the anonymized image. Alternatively or optionally additionally, the person region is, in particular, that region which is occupied by one or more persons segments of the person in the surveillance image and/or by the synthetic face and/or body model in the anonymized image. The background region is, in particular, that region in the surveillance image and/or anonymized image which is free of persons. In this case, the processing module is designed to insert the synthetic person model into the person region. In particular, the processing module is designed to insert the synthetic person model instead of the persons or person segments arranged in the person region into the surveillance image in order to generate the anonymized image. The configuration is therefore based on the consideration of providing an anonymization device which can divide a surveillance image into a region with personal data and a region without personal data, for example on the basis of a body of rules.

The invention also relates to a surveillance apparatus with at least one camera for video monitoring of the surveillance region. The surveillance apparatus in particular can comprise a plurality of cameras, wherein the anonymization device is connected through data technology to, for example, the plurality of cameras, so that the surveillance images of the plurality of cameras are made available to the anonymization device. The anonymization device is preferably integrated, and/or can be integrated, into one of the cameras and/or the surveillance apparatus. The anonymization device can, alternatively, however, also be connected externally to the at least one camera, in particular by way of the input interface. The anonymization and/or the generation of the anonymized images can in particular take place during ongoing operation, on-the-fly and/or instantaneously during image recording and/or monitoring by the anonymization device.

The invention also relates to a method for the generation of anonymized images. It is provided here that surveillance images are converted into anonymized images. The surveillance images are recorded, for example, by means of a camera. The surveillance images are subsequently converted into anonymized images in such a way that persons, or person segments, that are shown in the surveillance images and/or are included in them, are made unrecognizable and/or anonymized in the anonymized images. The anonymization takes place here in a plurality of steps, wherein a person included in the surveillance images is recognized in a first step, one or more items of personal information relating to the person are extracted in a second step, and a synthetic person model for anonymizing the person or the person segment is created in a further step on the basis of the personal information. In particular, the associated personal information is captured for each person or person segment in the surveillance images and is accordingly represented in an associated synthetic person model. The synthetic person model is preferably generated by the generative generic network. The synthetic person model is preferably inserted or overlaid in the surveillance images instead of the recognized person or person segment in order to anonymize the latter.

It is preferably provided that the face of the recognized person is analyzed in order to extract one or more facial features as the personal information. For example, the facial features may be determined by means of a facial recognition method. The facial features of the real person are then transferred to a synthetic face model, with the result that the synthetic face model has the same facial features as the real person. The face model generated as a result may be transferred to the surveillance images by overlaying or replacing the recognized person or person segment in order to generate the anonymized images.

Alternatively or optionally additionally, it is provided that one or more bodily parts or the entire body of the recognized person is/are analyzed in order to extract one or more body features as the personal information. For example the body features may be determined by means of a pose estimation method. The body features of the real person are then applied to a synthetic body model, with the result that the synthetic body model has the same body features as the real person. The body model generated as a result can be transferred to the surveillance images by overlaying or replacing the recognized person or person segment in order to generate the anonymized images.

In a further implementation, it is provided that the recognized person or the recognized person segment is removed from the surveillance images. In particular, the recognized person or person segment is removed from the segmented person region, in which case the background region remains. A corresponding synthetic person model is then generated on the basis of the personal information. The person, person segment or person region removed from the surveillance images is preferably exchanged for or replaced with the synthetic person model. In this case, the synthetic person model is inserted into the person region, with the result that the anonymized images are generated. An anonymization device that is used to provide anonymized images having a particularly high degree of correspondence to the real surveillance images is therefore proposed.

In a further embodiment, it is provided that the method is designed to generate and/or to store the anonymized images as training data for training an image processing algorithm. The method serves, for example, to convert a plurality of surveillance images into a plurality of training data, wherein the training data comprise the anonymized images. The training data here are in particular designed such that the persons are anonymized but nevertheless have such features, in particular the movement features of the real person, as are evaluated and/or are needed by an image processing algorithm. The generated training data and/or anonymized images can, for example, be provided to a machine learning algorithm for image evaluation software and/or to an image algorithm.

The invention also relates to a computer program, wherein the computer program is designed to carry out the method for the generation of the anonymized images when the computer program is executed on a computer, a processing unit or the anonymization device.

The invention also relates to a storage medium, wherein the storage medium comprises the computer program as previously described.

### BRIEF DESCRIPTION OF THE DRAWINGS

Further advantages, effects and configurations emerge from the appended figures and their description, in which:

FIG. 1 shows a schematic illustration of a surveillance apparatus with an anonymization device as one exemplary embodiment of the invention;

FIG. 2 shows a schematic illustration of the anonymization device from FIG. 1;

FIG. 3 shows a method for the generation of anonymized images on the basis of a flow diagram.

### DETAILED DESCRIPTION

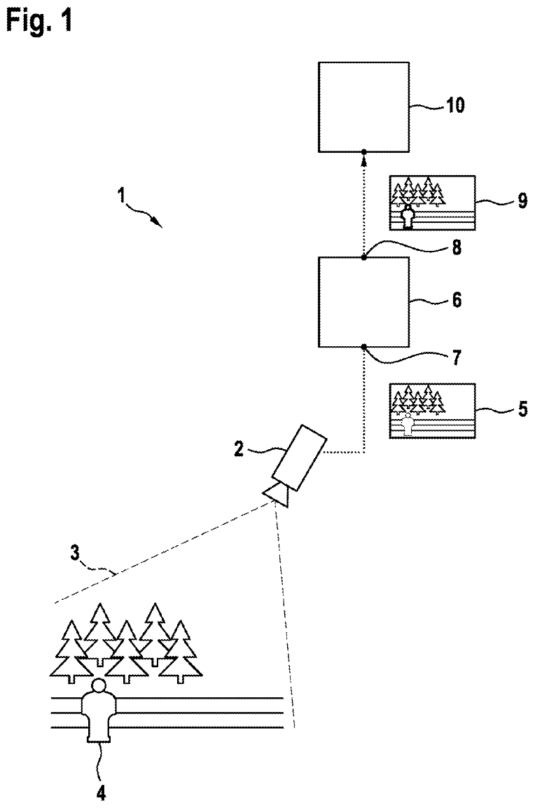

FIG. 1 shows a schematic illustration of a surveillance apparatus 1. The surveillance apparatus 1 comprises a camera 2 that is designed to monitor a surveillance region 3 through video technology. The camera 2 is, for example, designed as a video camera, preferably as a color camera. The surveillance region 3 is, for example, designed as a road, wherein the camera 2 can, for example, be installed in a vehicle, not illustrated.

At least one person 4 is located in the surveillance region 3, and can move freely therein. The person 4 is also monitored using video technology by means of the camera 2. The camera 2 here represents the surveillance region 3 in the form of surveillance images 5, wherein the camera 2 makes the surveillance images 5 available as video sequences, for example.

Very large amounts of data are needed to develop and test new algorithms, neural networks and artificial intelligences. For example, large amounts of such data arise in the field of security technology. However, these data often contain personal information, for example the image of the person in a video recording, which must be protected, in particular in the context of the General Data Protection Regulation (GDPR). Methods for anonymization by means of pixelation or by blackening faces or persons, for example, are known for this purpose. For example, an algorithm recognizes a person or only a face and places a pattern over the region to be protected in order to make the person unrecognizable. Other methods completely remove the person from the scene or place a solid area over the person, with the result that nothing more of the person can actually be recognized. The disadvantage of these methods is that the image material is greatly distorted and there is no longer the option for automatic data-supported learning from the image material. Even for people, it is also no longer possible to discern whether the person is carrying out a potentially dangerous action, for example drawing a weapon. So that these recordings can be used to develop and train data-driven algorithms, a new method is therefore required. This method must retain the relevant information in the image, on the one hand, but must reliably remove the personal information, on the other hand.

An anonymization of the surveillance images 5, while retaining the crucial features, that enables a further use for the development of algorithms that conforms with data protection is therefore proposed. For this purpose, the camera 2 is connected through data technology to an anonymization device 6. The anonymization device 6 has an input interface 7 for this purpose, wherein the camera 2 provides the surveillance images 5 to the input interface 7 of the anonymization device 6. The surveillance images 5 that are provided show the person 4, in particular in a non-anonymized form and/or as a real, recognizable image. The camera 2 can, for example, be connected to the anonymization device 6 by means of a wireless or wired connection. The anonymization device 6 can alternatively also be integrated into the camera 2.

The anonymization device 6 is designed to convert the surveillance images 5 into anonymized images 9. The anonymized images 9 comprise the persons 4 shown in the surveillance images 5 in anonymized form. The anonymization represents a data protection measure, so that the anonymized images 9 do not have any personal data by means of which the original person could be identified.

The anonymization device 6 comprises an output interface 8, for example a wireless interface or a wired interface, by means of which the anonymized images 9 can be provided to an external unit 10 or, alternatively, also directly to a person. Only the anonymized images 9 are provided here at the output interface 8, so that access to or the output of non-anonymized personal information is prevented. The external unit 10 can, for example, be a computing unit or a data collection center that needs images in order to train image processing algorithms. No personal information is typically required for the training of such image processing algorithms, so that the algorithm can also be trained using anonymized images 9.

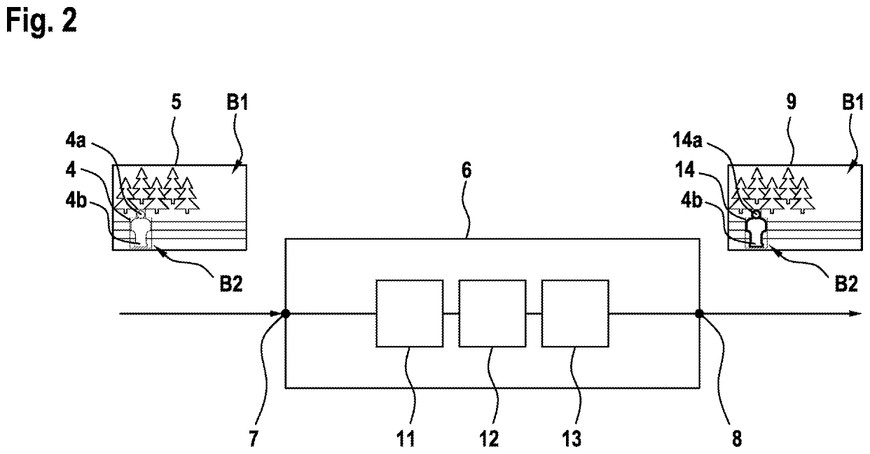

FIG. 2 shows a schematic illustration of the anonymization device 6 as an exemplary embodiment of the invention. The anonymization device 6 is, for example, designed as a processor, microchip or as a software module.

The anonymization device 6 comprises a recognition module 11, wherein the surveillance images 5 are provided via the input interface 7 to the recognition module 11. The recognition module can, for example, be designed as an electronic component, and connected through data technology, for example by way of a wired cable, to the input interface 7. The recognition module 11 has the function of checking the surveillance images 5 for persons 4, and of recognizing found persons 4 as such. The recognition module 11 can, for example, analyze the surveillance images 5 for particular characteristics, and assess whether something is a person 4 or an object on the basis of a body of rules.

The recognition module 11 is also designed to analyze the person 4 or person segments 4a, b in order to obtain personal information relating to the recognized person 4. In this case, the personal information may comprise one or more movement features and/or one or more appearance features of the person 4. In this case, a first person segment 4a comprises a face of the person 4, wherein the recognition module 11 is designed to extract one or more facial features of the face. Designed as a movement feature, the facial feature describes, for example, a facial expression and/or a direction of view of the person. Designed as an appearance feature, the facial feature or a further facial feature describes an age and/or a gender and/or a hairstyle and/or a skin color of the person. Furthermore, a second person segment 4b comprises a body of the person 4, wherein the recognition module 11 is designed to extract one or more body features of the body. Designed as a movement feature, the body feature describes, for example, gestures and/or a direction of movement and/or a movement speed of the person. Designed as an appearance feature, the body feature or a further body feature describes a stature and/or a height and/or clothing of the person, for example.

The anonymization device 6 comprises a segmentation module 12, wherein the surveillance images 5 with the recognized persons 4 or person segments 4a, b are provided to the segmentation module 12. The segmentation module 12 is, for example, designed as a further electronic component that is connected through data technology to the recognition module 11. The segmentation module 12 is designed to divide the surveillance image 5 into a background region B1 and a person region B2. In this case, regions in the surveillance image 5 which comprise the person 4 or the first and/or second person segment 4a, b are defined by the segmentation module 12 as the person region B2. Regions without persons 4 are defined by the segmentation module 12 as the background region B1.

The anonymization device 6 further comprises a processing module 13, wherein the segmented surveillance images 5, with the recognized persons 4 or person segments 4a, b and the associated personal information, are provided to the processing module 13. The processing module 13 is, for example, designed as a further electronic component that is connected through data technology to the segmentation module 12. The processing module 13 is designed to create a synthetic person model 14 on the basis of the personal information and replace the recognized persons 4 or person segments 4a, b in the surveillance images 5 with the synthetic person model 14. The processing module 13 preferably comprises a generative generic network in order to create the synthetic person models 14. The synthetic person models 14 here are realistic models of persons that are generated artificially, so that personal data, and/or data relevant to data protection law, are eliminated in the person models 14. In this case, the movement features can be used to transfer a movement of the real person 4 or person segments 4a, b to the synthetic person model 14. The appearance features can be used to transfer abstract physical features of the real person 4 or person segments 4a, b to the synthetic person model 14.

In this case, the person model 14 may be composed of a synthetic face model 14a and a synthetic body model 14b, wherein the synthetic face model 14a is generated on the basis of the facial features and the synthetic body model 14b is generated on the basis of the body features. In order to generate the anonymized images 9, the person 4 is replaced or overlaid with the person model 14 or the first person segment 4a is replaced or overlaid with the facial model 14a and/or the second person segment 4b is replaced or overlaid with the body model 14b, with the result that the real person 4 or person segments 4a, 4b can no longer be seen and/or identified in the anonymized images 9.

The anonymized images 9 can be used further in any desired manner since real persons 4 are no longer shown in the anonymized images 9 and personal rights to data protection are therefore no longer adversely affected. For example, the anonymized images 9 may be used to understand, for example, whether the persons 4 exhibit an abnormal behavior. In addition, an inherent annotation is already present by virtue of the synthetic person model 14, with the result that the anonymized image 9 can be easily used to train neural networks or other algorithms.

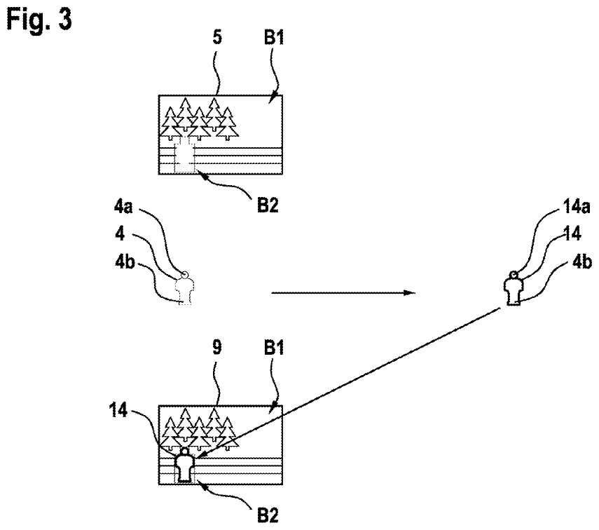

FIG. 3 shows, on the basis of a flow diagram, a method for the generation of the anonymized images 9, wherein the surveillance images 5 are converted into the anonymized images 9. In a first step, all persons 4 in the surveillance images 5 are recognized and their personal information is captured. The surveillance image 5 is then segmented into a background region B1 and a person region B2, wherein the person region B2 preferably comprises all persons 4 detected in the surveillance image 5.

In a further method step, the persons 4 or person segments 4a, b are removed from the person region B2 and replaced with the synthetic person model 14. For this purpose, the persons 4 or person segments 4a, b which are intended to be anonymized can be selected, for example. In order to generate the synthetic person models 14, the personal information is loaded into the generative generic network, for example a style transfer network (GAN), which uses said information to generate a photorealistic person model 14 with the same movement and/or appearance features as the real person 4. This newly generated person model 14 is used to generate, from the natural person 4, an artificial person model 14 which does not have any personal data which could be used to identify the original person. The synthetic person model 14 preferably provides an artificial, denaturalized person who moves like the real person 4 and also has the same abstract features.

The synthetic person model 14 is then inserted instead of the real person 4 into the person region B2 of the surveillance image 5 and the anonymized image 9 is thus generated. For example, only the synthetic face model 14a can be inserted instead of the first person segment 4a into the person region B2, wherein the second person segment 4b remains unchanged, with the result that only the face of the real person 4 is anonymized. The synthetic body model 14b can be optionally inserted instead of the second person segment 4b into the person region B2, with the result that the entire person 4 is anonymized. The persons 4 or person segments 4a, b are distorted by the method such that they are anonymized, but the facial features (facial expressions) and/or action features (gestures) of the real person 4 are retained.

The entire process for generating the anonymized images 9 can be carried out locally and may be a type of export of the surveillance images 5. For example, an airport which must not release any video data according to the current legal situation could locally convert its surveillance images 5 into the anonymized images 9. This then allows these data to be shared, from which others could learn.

1. An anonymization device (6) for the generation of anonymized images (9), wherein surveillance images (5) are provided through video monitoring of a surveillance region (3) by means of at least one camera (2), the anonymization device comprising:
a recognition module (11),
wherein the surveillance images (5) are provided to the recognition module (11), wherein the recognition module (11) is configured to recognize persons (4) included in the surveillance images (5),
a processing module (13),
wherein the processing module (13) is designed to process the surveillance images (5) into the anonymized images (9), wherein at least one person (4) or person segment (4a, b) included in the surveillance images (5) is anonymized in the anonymized images (9),
wherein
the recognition module (11) is designed to capture personal information relating to the recognized person (4), wherein the processing module (13) is designed to create a synthetic person model (14) for anonymizing the person (4) on the basis of the personal information.

2. The anonymization device (6) as claimed in claim 1, wherein the processing module (13) comprises a generative generic network for generating the synthetic person model (14).

3. The anonymization device (6) as claimed in claim 1, wherein the personal information comprises at least one movement feature and/or at least one appearance feature of the person (4).

4. The anonymization device (6) as claimed in claim 1, wherein the processing module (13) is designed to animate the person model (14) on the basis of the personal information in order to generate an animated synthetic person model (14).

5. The anonymization device (6) as claimed in claim 1, wherein the personal information comprises at least one facial feature of a face of the recognized person (4), wherein the synthetic person model (14) is designed as a synthetic face model (14a) with the at least one facial feature.

6. The anonymization device (6) as claimed in claim 1, wherein the personal information comprises at least one body feature of a body or of at least one bodily part of the recognized person (4), wherein the synthetic person model (14) is designed as a synthetic body model (14b) with the at least one body feature.

7. The anonymization device (6) as claimed in claim 1, wherein the processing module (13) is designed to insert the synthetic person model (14) instead of the person (4) or the person segment (4a, b) into the anonymized image (9).

8. The anonymization device (6) as claimed in claim 7, further comprising a segmentation module (12), wherein the segmentation module (12) is designed to segment the surveillance image (5) into a background region (B1) and a person region (B2), wherein the processing module (13) is designed to insert the synthetic person model (14) into the person region (B2).

9. A surveillance apparatus (1) with at least one camera (2) for video monitoring of a surveillance region (3), wherein surveillance images (5) are provided by the camera (2), with an anonymization device (6), the anonymization device including
a recognition module (11),
wherein the surveillance images (5) are provided to the recognition module (11), wherein the recognition module (11) is configured to recognize persons (4) included in the surveillance images (5),
a processing module (13),
wherein the processing module (13) is designed to process the surveillance images (5) into the anonymized images (9), wherein at least one person (4) or person segment (4a, b) included in the surveillance images (5) is anonymized in the anonymized images (9),
wherein
the recognition module (11) is designed to capture personal information relating to the recognized person (4),
wherein the camera (2) and the anonymization device (6) are communicatively connected to one another, wherein the processing module (13) is designed to create a synthetic person model (14) for anonymizing the person (4) or a person segment (4a, b) on the basis of the personal information.

10. A method for the generation of anonymized images (9), wherein surveillance images (5) are converted into anonymized images (9), wherein at least one person (4) included in the surveillance images (5) is recognized, personal information relating to the person (4) is extracted, and a synthetic person model (14) for anonymizing the person (4) or a person segment (4a, b) is created on the basis of the personal information.

11. The method as claimed in claim 10, wherein a face of the person (4) is analyzed and at least one facial feature of the face is extracted as personal information, wherein a synthetic face model (14a) is generated as the synthetic person model (14) on the basis of the facial feature, and/or in that a body of the person (4) is analyzed and at least one body feature of the body is extracted as personal information, wherein a synthetic body model (14b) is generated as the synthetic person model (14) on the basis of the body feature.

12. The method as claimed in claim 10, wherein the recognized person (4) or person segment (4a, b) is removed from the surveillance images (5) and is replaced with the synthetic person model (14), with the result that the anonymized images (9) are generated.

13. The method as claimed in claim 10, wherein the anonymized images (9) are generated and/or stored as training data for training an image processing algorithm.

14. (canceled)

15. A computer readable medium containing instructions that when executed by a computer cause the computer to
convert surveillance images (5) into anonymized images (9), wherein at least one person (4) included in the surveillance images (5) is recognized, personal information relating to the person (4) is extracted, and a synthetic person model (14) for anonymizing the person (4) or a person segment (4a, b) is created on the basis of the personal information.
